(19) United States
(12) Patent Application Publication
(10) Pub. No.: US 2014/0012594 A1
(43) Pub. Date: Jan. 9, 2014

(54) Clinical Outcome-Dependent Medical Intervention Cost Reimbursement System

(71) Applicant: Alfred E. Slanetz, Cohasset, MA (US)

(72) Inventor: Alfred E. Slanetz, Cohasset, MA (US)

(73) Assignee: GENEIUS BIOTECHNOLOGY INVESTMENTS, LLC, Cohasset, MA (US)

(21) Appl. No.: 13/997,540

(22) PCT Filed: Dec. 23, 2011
(86) PCT No.: PCT/US11/67166

§ 371 Date: Sep. 23, 2013

Related U.S. Application Data
(60) Provisional application No. 61/426,697, filed on Dec. 23, 2010.

(51) Int. Cl. G06Q 50/22; G06Q 40/08

(52) U.S. Cl. CPC G06Q 50/22; G06Q 40/08
USPC 705/2

(57) ABSTRACT

Medical intervention cost reimbursement on a clinical outcome-dependent basis may be implemented through a periodic cost reimbursement instrument, such as an annuity, associated with the delivery of acute or other discrete event medical intervention, such as gene therapy, cell therapy, or medical nanotechnology.

### FIELD OF THE INVENTION

The present application relates to a novel system for establishing and managing medical intervention cost reimbursement on a clinical outcome-dependent basis. The system contemplates, for example, the association of a periodic cost reimbursement instrument, such as an annuity, with the delivery of acute or other discrete event medical intervention, such as gene therapy, cell therapy, or medical nanotechnology.

### BACKGROUND OF THE INVENTION

Medical intervention may include prophylactic and therapeutic applications that are delivered on a chronic, continuous basis or on an acute, discrete basis, relatively speaking. The medical interventions that are delivered on an acute or other discrete event basis present a potential paradigm for the reimbursement of costs associated with addressing health conditions that depends on the value to the patient as measured by a particular clinical outcome as opposed to cost of the medical intervention itself. For example, recent gene and cell therapies would be amenable to a medical intervention cost reimbursement on a clinical outcome-dependent basis.

Traditional pharmaceutical and biotechnology products are administered to chronically manage disease and are administered on a routine basis, for example, 1, 2, or 4 times per day, weekly, biweekly, etc., generally as a pill or as an injection. The commercial model is to receive compensation for each unit, which may be, for example, a pill, patch, injection or inhaler. Generally, the payer, for example, an insurance company, reimburses on a per-pill or per-prescription basis. Particularly with premium priced products, payers have established a number of strategies to control utilizations by, for example, placing drugs on formularies, or requiring preapprovals or copayments. For drugs with varying clinical results in patients particularly where there are therapeutic alternatives, pharmaceutical companies have negotiated a pay for performance model in which they agree to reimburse the payer a percentage of the payment made if the patient does not reach a particular endpoint. However, there has not been payment solely on clinical outcome nor have there been payments year after year without subsequent prescription or utilization.

In contrast to a traditional pharmaceutical product which is administered chronically, a gene or cell therapy is generally designed to be given as a one-time therapy correcting the basis of the disease. The commercial assessments of such technologies in the traditional pharmaceutical business model present challenges including limits on what one can charge for a single treatment, the necessity to calculate markets on incidence rather than prevalence (particularly critical as there are 8000 orphan monogenetic diseases, most of which are exceedingly rare), the cost of goods sold is higher than traditional pharmaceutical margins and the commercial model is often seen as a service rather than a pharmaceutical product. These factors are one of the reasons most pharmaceutical companies have decided not to invest in the development and commercialization of gene and cell therapies.

Therefore, there is a need within the art to provide a clinical outcome-dependent medical intervention cost reimbursement system that would reflect a more accurate value to the patient and that would incentivize health care entities, such as pharmaceutical companies, to invest in the development and commercialization of acute or other discrete event medical intervention, such as gene therapy, cell therapy, or medical nanotechnology, as well as other one-time curative therapies.

### SUMMARY OF THE INVENTION

The present invention includes systems for establishing and managing medical intervention cost reimbursement on a clinical outcome-dependent basis. The systems of the present invention contemplate, for example, the association of a periodic cost reimbursement instrument, such as an annuity, with the delivery of acute or other discrete event medical intervention, such as gene therapy, cell therapy, or medical nanotechnology.

### DETAILED DESCRIPTION OF THE INVENTION

When used in the claims, the terms “a” and “an” and “the” and similar references in the context of describing the invention (especially in the context of the following claims) are to be construed to cover both the singular and the plural, unless otherwise indicated herein or clearly contradicted by context. Also when used in the claims, the terms “comprising,” “having,” “including,” and “containing” are to be construed as open-ended terms (i.e., meaning “including, but not limited to,”) unless otherwise noted. To the extent used, the recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. Variations of the embodiments may become apparent to those of ordinary skill in the art upon reading the description. Accordingly, this invention includes all modifications and equivalents of the subject matter recited in the claims appended hereto as permitted by applicable law. Moreover, any combination of the described elements in all possible variations thereof is encompassed by the invention unless otherwise indicated herein or otherwise clearly contradicted by context.

All patents and other publications are incorporated herein by reference for the purpose of describing and disclosing, for example, the methodologies described in such publications that might be useful in connection with the present invention. These publications are provided solely for their disclosure prior to the filing date of the present application. Nothing in this regard should be construed as an admission that the inventors are not entitled to antedate such disclosure by virtue of prior invention or for any other reason.

In an embodiment of the present invention, a model for annuity pricing of one-time curative therapies is developed. The model developed and contemplated herein benefits the development and use of any therapy that is not chronic, long-term or continuous therapy. One-time curative therapies may include prophylactic applications, such as vaccines, and therapeutic applications, and may include pharmaceutical treatments. One-time curative therapies may also include, for example, a series of administrations over a period of time that is shorter in duration than comparable, chronic treatment methods, or a treatment that is provided at discrete intervals within a calendar year as opposed to daily, ongoing management of a particular condition. As defined herein, one-time curative therapies are not limited to single event medical intervention.

The model begins with a company partnership or fund created for the purpose of receiving payments from a payer. Instead of receiving only one payment for a drug at the time of administration, the payer pays an annual payment to the company for each patient still responding. The company would charge third party payers as an annuity based on one of the following alternatives, including, for example, the money saved by a payer by not using, for example, an enzyme replacement therapy, paid for every year of survival without the need of enzyme replacement therapy. A similar, though more complex formula could be used for treatments of other diseases like cancer, based on survival, alternative costs and years of productivity. This annual payment may be fixed or vary from year to year. In one embodiment, the payment schedule may step down as specific clinical milestones are achieved, e.g., a preset time period passes without a patient requiring rescue therapy or hospitalization. The payment frequency may be monthly, quarterly or annually, and may vary.

While the clinical benefit has influence and can raise the annual payment, the annual payment is generally set at or below the total annual cost of managing that clinical indication (including, pharmaceuticals, hospitalization, outpatient care, physician fees, diagnostics, etc.). The payer does not pay for these other parts of the value chain as long as one-time therapy is working. Third party payers could include insurance companies, Medicare, Medicaid, VA, employers, provider organizations, capitated healthcare plans, government health authorities or other intermediaries. This approach is particularly attractive when addressed in the context of capitated patient/payer models and with patient centered healthcare, such as, for example, those enabled by primary care physicians. An annuity instrument can be structured as a contract, re-insurance agreement, escrow or bond for a fixed term. The term could vary from 2 to 100 years or could be set over a specified period of weeks or months depending upon indication. The contract and escrow annuity would be attractive to insurance companies and certain government health authorities. An optimal term duration would reflect both the payer's comfort level with a specific pre-defined term as well as the benefit of cash flow over a period long enough to allow for discounted value calculations.

Other factors relevant to the determination of the duration and amount of the periodic cost reimbursement instrument may include the term of patent, regulatory and/or data exclusivity associated with the medical intervention. The determination of the duration and amount of the periodic cost reimbursement instrument may also include considerations of the relative success of the medical intervention based on individual clinical outcome (but also possibly actuarial data, pooled securities, and the like), as observable by events such as in-patient or out-patient visits or hospitalization as well as insurance claim filings, based upon medical events such as relapse, recurrence, and efficacy decline, that suggest the need for further medical intervention, such as rescue therapy or boost.

In another embodiment, a financial instrument is structured as a reverse annuity at the outset to monetize the therapy upfront and pay interest to a holder of the financial instrument.

The cash flow represented by the annuity instrument provides a vehicle by which to finance late stage development and commercial build-out. The beneficial effect of the annuity revenue and cash flow may extend the revenue stream of a particular one-time curative treatment beyond, for example, the normal patent expiration as the annuity is not tied to patent coverage, but to therapeutic benefit.

This model is particularly attractive for high response rate indications and encourages the development of efficacious therapies with long term benefit even if they are one time or low frequency (e.g., 2 or 3 cycles of therapy) interventions. It also provides a prevalence-based annual revenue stream which provides potential to capture predictable revenue stream based upon prevalence of disease and grow the prevalence by reducing mortality. This allows the pharmaceutical company to capture the value of a drug with a long term survival benefit or other long term outcome and, for orphan diseases with low incidence, allows a prevalence-based commercial return which often will justify development of the drug or other treatment modality by a pharmaceutical company rather than a decision not to develop. Furthermore, payers are more willing to pay for outcomes rather than an intervention which may or may not have a result. This is particularly true for diseases which are expensive to chronically manage and reach the level of risk managers at the payer. Finally, because there is a very low to no cost for the revenue in the time periods, for example, quarters or years, after therapy, annuity pricing significantly improves operating margins over traditional biopharmaceutical commercialization model and can enable a positive development decision to be taken even if the cost of goods would be high if the drug were traditionally priced in one payment.

Annuity pricing is a transformative business model for the pharmaceutical industry. It creates a new basis of competition in the industry. Rather than selling pills, it sells outcomes directly to the payers aligning the goals of all stakeholders with the health of the patient. Instead of monetizing the cost of treatment this approach monetizes the value of curing the patient. It is both higher value and more cost effective: capturing value and saving costs from multiple parts of the traditional healthcare value chain, including Pharmaceuticals, Hospital, Outpatient and Providers.

It provides patients with a better clinical outcome and quality of life, aligns product development with clinical outcomes and allows for the development of one time curative therapies which traditional pharmaceutical model has overlooked. It is a new commercial model for gene and cell therapy as well as other one time curative therapies. The outcome of the patient is what matters and the annuity pricing model incentivizes the development of highly effective/curative therapies rather than those which merely allow chronic and/or palliative management of a disease.

### SPECIFIC EXAMPLES

For example, Epstein-Barr virus-specific cytotoxic T lymphocytes (EBV CTL) have been used to treat lymphoma and Nasopharyngeal carcinoma. Clinical data indicates 80% survival of lymphoma patients treated with EBV CTL for 2+ years median and up to 6 years when cells are administered when the patient is put into remission with traditional therapy. Further, 50% of lymphoma patients with bulky relapsed disease achieved complete responses which have been durable for 1.5+ years. Bollard et al., 110(8) Blood 2838-45 (2007). EBV CTL have also been demonstrated to result in 72% survival of patients with locoregional Nasopharyngeal carcinoma (NPC). Louis et al., 33(9) J Immunotherapy 983-90 (2010). Because the product is a one-time therapy with a high response rate and lymphoma and NPC are very expensive to chronically manage, payers would welcome the opportunity to pay for positive outcomes over a period of time.

EBV CTL have also been shown to prevent the development of EBV related lymphoproliferative disease (LPD) in transplant recipients (Heslop et al., 115(5) Blood 925-35 (2010)) and multivirus CTL have been shown to prevent LPD and complicating infections by other viruses (e.g. cytomegalovius, adenovirus) improving the outcome of transplant patients (Gerdemann et al., 17(9) Molecular Therapy 1616-25 (2009)). Because the product is a one-time therapy which eliminates transplant complications which are very expensive to chronically manage, payers would welcome the opportunity to pay for positive outcomes over a period of time.

The same is true for orphan diseases such as severe combined immunodeficiency due to the lack of adenosine deaminase (ADA SCID) where, for example, 80% of patients treated in an Italian study with human bone marrow stem cells, where the corrected gene was inserted into the cells by gene therapy, have remained disease free for up to 8.5 years with a median follow up of 4.5 years. Aiuti et al., 360(5) N. Eng. J. Med 447-58 (2009). The ADA SCID therapy provides a better outcome and may prevent the need for expensive enzyme replacement therapy and hospitalization/ICU visits. ADA SCID is typically very expensive to manage with an annual management cost of $475,000. Thus, providing one-time gene therapy at a cost of up to $400,000 per year would be lower than the current standard of care while concurrently providing a superior outcome. The initial plan is to enter contractual obligation with EU government health authorities and Medical Insurance companies (United Health, Aetna, Anthem Blue Cross) and Capitated plans (e.g., Geisinger, Kaiser Permanente), etc. in which the payer agrees to pay $400,000 at the time of treatment and an additional $400,000 on the one year anniversary of such treatment for each patient who has not required rescue therapy with the enzyme replacement therapy (ADA PEG) or allogeneic bone marrow transplantation in that year for a period up to and including the 12^{th} year post therapy. Twelve years was negotiated as the payer wanted a way to calculate the total cost they were potentially committing to providing the patient continued to benefit from and this length of time allows the company to structure an annuity instrument around the future cash flow from the contractual obligation which can be used to finance the prelaunch build out of development and commercialization and other activities.

This model may be followed for other gene/ cell therapies for diseases including, but not limited to, Adrenoleukodystrophy (ALD), Metachromatic Leukodystrophy (MLD), Hurler's Syndrome, Globoid Cell Leukodystrophy, Lebers congenital amaurosis, Stargardts disease, Dry AMD, Wet AMD, Retinitis Pigmentosa, thalassemia, sickle cell disease, Hemophilia A, Hemophilia B, Wiskott Aldrich Disease, X SCID, Chronic Granulomatous Disease (CGD), Parkinsons Disease, Alzheimers disease, congestive heart failure, thymidine kinase, and Tumor Infiltrating Lymphocytes (TILS). Genes or cells could be introduced in vivo or ex vivo, the cells could be somatic or stem cells, the genes could be inserted/ corrected using viral as well as non-viral vectors, plasmid DNA, homologous recombination, regulatory elements, and other techniques available to those skilled in the art. Most, if not all, other gene/cell therapies/regenerative medicines would benefit from and potentially only be enabled by a periodic cost reimbursement instrument such as an annuity pricing commercial approach.

In other embodiments, medical intervention involving nanotechnology, such as those relating to magnetic and radiotherapy, are contemplated as acute or other discrete event medical intervention that could benefit from and be enabled by clinical outcome-dependent medical intervention cost reimbursement system such as an annuity pricing commercial approach.

Detailed embodiments of the present invention are disclosed herein; however, it is to be understood that the disclosed embodiments are merely exemplary of the invention that may be embodied in various forms. It will be appreciated that many modifications and other variations that will be appreciated by those skilled in the art are within the intended scope of this invention as claimed below without departing from the teachings, spirit and intended scope of the invention.

What is claimed is:

1. A system comprising a periodic cost reimbursement instrument wherein the reimbursements are based on a clinical outcome assigned to a medical intervention event.

2. The system of claim 1, wherein the instrument comprises an annuity.

3. The system of claim 2, wherein the annuity is selected from the group consisting of a fixed-term contract, a reinsurance agreement, an escrow, and a bond.

4. The system of claim 1, wherein the instrument comprises a reverse annuity.

5. The system of claim 1, wherein the event is an acute event.

6. The system of claim 1, wherein the event comprises a therapy selected from the group consisting of gene therapy, cell therapy, or medical nanotechnology.
